(19) United States
(12) Patent Application Publication
(10) Pub. No.: US 2015/0369337 A1
(43) Pub. Date: Dec. 24, 2015

(54) HIGH-SPEED ROTATING MACHINE

(71) Applicant: HANWHA TECHWIN CO., LTD., CHANGWON-SI (KR)

(72) Inventor: Werner BOSEN, Houston, TX (US)

(73) Assignee: SAMSUNG TECHWIN CO., LTD., Changwon-si (KR)

(21) Appl. No.: 14/312,042

(22) Filed: Jun. 23, 2014

(51) Int. Cl. F16H 1/06; F04D 29/60; F16H 57/021

(52) U.S. Cl. CPC F16H 1/06; F16H 57/021; F04D 29/601

(57) ABSTRACT

A high-speed rotating machine includes a case, a balancing unit connected to the case in a state in which a dynamic balance of the balancing unit is already adjusted, and configured to rotate in order to compress or expand air to be supplied to the outside, a gear box connected to the case; and a bull gear connected to the gear box and inserted in the balancing unit in order to be connected to the balancing unit and to transfer a rotational force of the gear box to the balancing unit.

### BACKGROUND

1. Field

One or more exemplary embodiments of the present disclosure relate to a high-speed rotating machine.

2. Description of the Related Art

In general, a high-speed rotating machine may be provided at a variety of apparatuses. The high-speed rotating machine may include a compressor and an expender. The high-speed rotating machine may include a case that is provided outside the high-speed rotating machine, a gear box for transferring power, a bull gear connected to the gear box, and a rotator connected to the bull gear. The high-speed rotating machine may be generally manufactured through core assembly.

In detail, the high-speed rotating machine may correct the position, height, or material of each of constituent elements by measuring balance in a state in which the case, the gear box, the bull gear, and the rotator are assembled together, and may correct the position, height, or material of each constituent element by measuring dynamic balance while rotating the rotator. When the balance of a rotating body such as the rotator matters, the rotating body may be balanced by repeatedly performing processes of disassembling the high-speed rotating machine in a reverse order, adjusting balance, and assembling the high-speed rotating machine.

Japanese Patent Publication No. 2003-174742 (“Rotary Machine And Assembling Method Thereof”, applicant: IHI CORP) discloses the above method in detail.

### SUMMARY

One or more exemplary embodiments of the present disclosure include a high-speed rotating machine.

Additional aspects will be set forth in part in the description which follows and, in part, will be apparent from the description, or may be learned by practice of the exemplary embodiments presented herein.

According to one or more exemplary embodiments of the present disclosure, a high-speed rotating machine includes a case, a balancing unit connected to the case in a state in which a dynamic balance of the balancing unit is already adjusted, and configured to rotate in order to compress or expand air to the outside, a gear box connected to the case, and a bull gear connected to the gear box and inserted in the balancing unit in order to be connected to the balancing unit and to transfer a rotational force of the gear box to the balancing unit.

The balancing unit includes a pinion gear shaft connected to the bull gear, at least one bearing provided between the case and the pinion gear shaft to rotatably support the pinion gear shaft, a bearing housing coupled to the case, the at least one bearing being arranged inside the bearing housing, and an impeller connected to an end portion of the pinion gear shaft and configured to rotate.

The pinion gear shaft, the at least one bearing, the bearing housing, and the impeller may be provided in an assembled state and the balancing unit may be provided in the case.

After the pinion gear shaft, the at least one bearing, the bearing housing, and the impeller are assembled and dynamic balance of each of the pinion gear shaft, the at least one bearing, the bearing housing, and the impeller is adjusted, the balancing unit may be provided in the case.

The balancing unit may further include a shaft seal that is provided between the bearing housing and the pinion gear shaft, the shaft seal being provided at least one of opposite ends of the pinion gear shaft.

The at least one bearing may be an angular contact ball bearing that supports an irregular load generated according to rotation of at least one of the pinion gear shaft and the impeller.

The balancing unit may include at least one un-split bearing.

The at least one un-split bearing may be substantially devoid of bearing clearance.

According to one or more exemplary embodiments of the present disclosure, a method of assembling a high-speed rotating machine that includes: a case; a balancing unit connected to the case in a state in which a dynamic balance of the balancing unit is already adjusted, and configured to rotate in order to compress or expand air to be supplied to the outside; a gear box connected to the case; and a bull gear connected to the gear box and inserted in the balancing unit in order to be connected to the balancing unit and to transfer a rotational force of the gear box to the balancing unit, the method includes: dynamically balancing the balancing unit; and connecting the balancing unit to the case without disassembling the dynamically balanced balancing unit.

### BRIEF DESCRIPTION OF THE DRAWINGS

These and/or other aspects will become apparent and more readily appreciated from the following description of the exemplary embodiments, taken in conjunction with the accompanying drawing in which:

FIG. 1 is a cross-sectional view of high-speed rotating machine according to an exemplary embodiment of the present disclosure.

### DETAILED DESCRIPTION

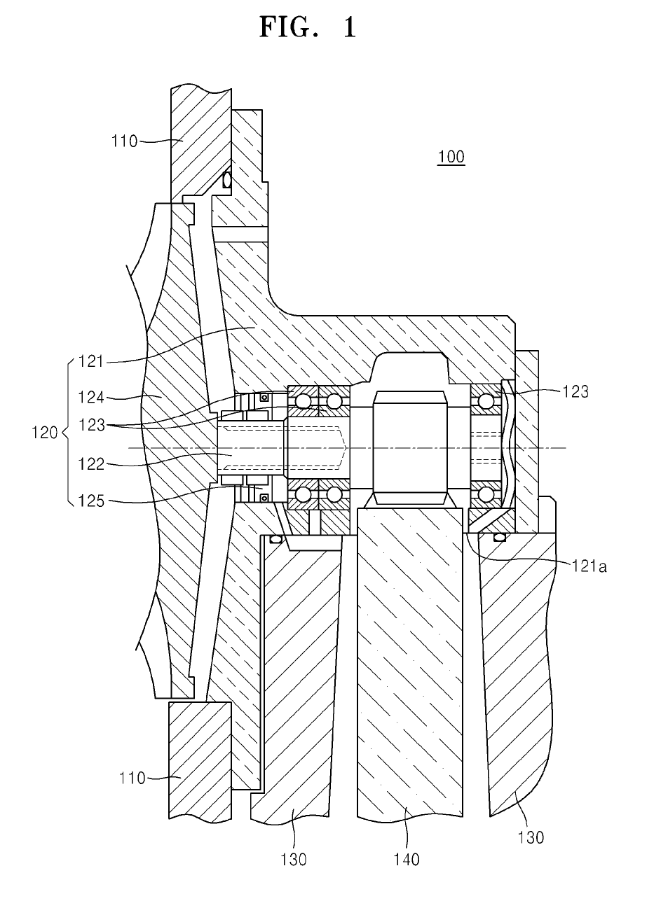

Reference will now be made in detail to an exemplary embodiment, an example of which is illustrated in the accompanying drawing, wherein like reference numerals refer to like elements throughout. In this regard, the present exemplary embodiment may have different forms and should not be construed as being limited to the descriptions set forth herein. Accordingly, the exemplary embodiment is merely described below, by referring to FIG. 1, to explain aspects of the present disclosure. Terms is used in the present specification are used for explaining a specific exemplary embodiment, not for limiting the present disclosure. Thus, the expression of singularity in the present specification includes the expression of plurality unless clearly specified otherwise in context. Also, terms such as “comprise” and/or “comprising” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

In the present specification, terms such as “first” and “second” are used herein merely to describe a variety of members, parts, areas, layers, and/or portions, but the constituent elements are not limited by the terms. It is obvious that the members, parts, areas, layers, and/or portions are not limited by the terms. The terms are used only for the purpose of distinguishing one constituent element from another constituent element. As used herein, the term “and/or” includes any and all combinations of one or more of the associated listed items. Expressions such as “at least one of,” when preceding a list of elements, modify the entire list of elements and do not modify the individual elements of the list.

As set forth above, in related high-speed rotating machines, a sub-assembly unit must be balanced and disassembled before reassembly onto the gear box. Since rotors of the sub-assembly unit are disassembled after the rotor balancing procedure, the rotor balancing quality upon reassembly of the sub-assembly is reduced. This reduction in rotor balancing quality upon reassembly requires expensive high speed balancing in a special balancing rig or in situ balancing within the core-assembly.

According to an aspect of the present disclosure, the sub-assembly unit (e.g., balancing unit) can be balanced and then assembled onto a gear box without the need for disassembly and reassembly of the sub-assembly unit.

According to another aspect of the present disclosure, non-split bearings, such as antifriction bearings, can be used without creating practically unsolvable problems for bearing maintenance which is a maintenance issue for any kind of high speed machinery.

As described in greater detail below, a rigid bearing housing may be used for each pinion-rotor which may permit both easy assembly onto sensor-ports of a dynamic balancing machine and the installation of un-split bearings. In some embodiments, the un-split bearings are pre-loaded angular contact ball bearings which may allow the balancing procedure because of absence of any bearing clearance. As a result, direct signal information of residual un-balance forces from the rotor may be received by sensor-ports of the balancing machine.

FIG. 1 is a cross-sectional view of a high-speed rotating machine 100 according to an exemplary embodiment of the present disclosure.

Referring to FIG. 1, the high-speed rotating machine 100 may be an expander or a compressor. The high-speed rotating machine 100 may be provided at a turbo apparatus or a turbine apparatus. In the following description, for convenience of explanation, a case that the high-speed rotating machine 100 is a compressor is mainly discussed in detail.

The high-speed rotating machine 100 may include a case 110 that forms external appearance. The high-speed rotating machine 100 may include a balancing unit 120 that is provided inside the case 110. The balancing unit 120 may be rotated by receiving external rotating power, thereby compressing or expanding air.

The high-speed rotating machine 100 may include a gear box 130 that is connected and coupled to the balancing unit 120. A plurality of gears may be arranged in the gear box 130. Also, one of the gears may be connected to a driving unit (not shown) such as a motor.

The high-speed rotating machine 100 may include a bull gear 140 that connects the gear box 130 and the balancing unit 120. The bull gear 140 may rotate at a low speed and may be connected to the gears in the gear box 130 so as to transfer driving power of the driving unit to the balancing unit 120.

The balancing unit 120 may be provided inside the case 110. In detail, the balancing unit 120 is provided inside the case 110 and may include a bearing housing 121 that is connected to the gear box 130. The bearing housing 121 may have an internal space to accommodate a variety of constituent elements. An insertion hole 121a, in which the bull gear 140 is inserted, may be formed in the bearing housing 121.

The balancing unit 120 may include a pinion gear shaft 122 that is rotatably provided inside the bearing housing 121 and connected to the bull gear 140. Gear teeth formed on the pinion gear shaft 122 may be engaged with gear teeth of the bull gear 140 so that the pinion gear shaft 122 and the bull gear 140 may rotate relative to each other.

The balancing unit 120 may include at least one bearing 123 that is provided between the bearing housing 121 and the pinion gear shaft 122. The bearing 123 may rotatably support the pinion gear shaft 122. In particular, the bearing 123 may be an angular contact ball bearing that is previously provided in the bearing housing 121.

The bearing 123 may support an irregular load that is generated according to rotation of at least one of the pinion gear shaft 122 and an impeller 124. Also, the bearing 123 may be provided in multiple numbers. In this case, a plurality of bearings 123 may be provided to be separated from one another to rotatably support the pinion gear shaft 122.

The balancing unit 120 may include the impeller 124 that is connected to an end portion of the pinion gear shaft 122 and rotated. The impeller 124 may compress or expand external air by sucking the external air.

The balancing unit 120 may include a shaft seal 125 that is provided between the bearing housing 121 and the pinion gear shaft 122. The shaft seal 125 may be provided in multiple numbers. In this case, a plurality of shaft seals 125 may be provided to be separated a predetermine distance from one another. In particular, the shaft seal 125 may be provided at least one of opposite ends of the pinion gear shaft 122 and seal the inside of the bearing housing 121 from the outside.

In a method of assembling the high-speed rotating machine 100, the balancing unit 120 may be assembled and supported on a separate support member before being provided in the gear box 130. In detail, the pinion gear shaft 122, the bearing 123, and the shaft seal 125 are provided inside the bearing housing 121 and the impeller 124 may be provided at an end portion of the pinion gear shaft 122.

When the assembly of the balancing unit 120 is completed, balance of each constituent element may be adjusted in advance in an assembled state. For example, the size, position, or applied load of each of the pinion gear shaft 122, the bearing 123, and the shaft seal 125 is changed so that the pinion gear shaft 122, the bearing 123, and the shaft seal 125 may be adjusted to fit to a state that is appropriate for the rotation of the pinion gear shaft 122.

When the above process is completed, the bull gear 140 is provided in the gear box 130 and the gear box 130 may be connected to the bearing housing 121. The bull gear 140 may enter the inside of the bearing housing 121 through the insertion hole 121a and may be connected to the pinion gear shaft 122.

Also, while the above process is performed, the case 110 may be coupled to the bearing housing 121. The case 110 and the bearing housing 121 may be coupled to each other by using screws, bolts, welding, etc.

In general, when the high-speed rotating machine 100 is assembled, the respective constituent elements may be separately manufactured and supplied. In doing so, balance between the respective constituent elements may vary with respect to each other or the balance between the respective constituent elements may be mismatched due to rotation during the operation of the high-speed rotating machine 100 so that efficiency of the high-speed rotating machine 100 may be lowered or the high-speed rotating machine 100 may be damaged or may malfunction.

In particular, when the high-speed rotating machine 100 is completely assembled, dynamic balance adjustment may be performed. In detail, rotating portions of the pinion gear shaft 122, the impeller 124, and the bearing 123 may vibrate or may be dislocated due to rotation. To prevent the above matters, the positions or heights of the pinion gear shaft 122, the impeller 124, and the bearing 123 may be adjusted to make balance therebetween. The above balancing process is performed while the bearing housing 121 is disassembled.

When the above balancing process is not performed first, the positions of the constituent elements may be mismatched due to even a slight error. In particular, a rotating body such as the rotating portions of the pinion gear shaft 122, the impeller 124, and the bearing 123 may be damaged or may malfunction during rotation due to the above error.

However, in the high-speed rotating machine 100 according to the present exemplary embodiment, the balancing unit 120 may be provided in the case 110 and the gear box 130 after the balancing unit 120 is assembled in advance and dynamic balance thereof is adjusted in advance. Unlike the related art, it is not required to disassemble the balancing unit after a balancing operation in order to assemble the balancing unit to the case 110.

Accordingly, in the high-speed rotating machine 100 according to the present exemplary embodiment, dynamic balance or separate balance needs not be adjusted after the balancing unit 120 is provided in the case 110 and the gear box 130 so that a working time may be reduced and damage and malfunction may be prevented.

When repair or replacement is needed after the above assembly process is performed, the above assembly process may be performed in a reverse order. For example, the bull gear 140 may be separated from the pinion gear shaft 122 by separating the case 110 and the gear box 130.

Then, the balancing unit 120 may be replaced with a new balancing unit, or the balancing unit 120 may be moved to the outside so that a broken part may be repaired by disassembling the bearing housing 121.

Accordingly, in the high-speed rotating machine 100 according to the present exemplary embodiment, not only is the generating efficiency of the high-speed rotating machine 100 improved, but also a broken part may be easily replaced during repair.

As described above, according to the one or more of the above exemplary embodiments of the present disclosure, the high-speed rotating machine may be simply and easily assembled. More specifically, the balancing 120 unit does not need to be disassembled after the balancing procedure, which means that the balancing unit 120 also does not need to get reassembled during the final core assembly. In this way, the balancing quality of the pinion gear shaft 122 and of the impeller 124, as well as all of the rotating parts of the bearings 123 and the shaft seal 125 remains as originally achieved within a balancing rig, where the balancing unit 120 is installed as a completely sub-assembled unit in order to dynamically balance the pinion gear shaft 122, the overhung mounted impeller 124 and all of the rotating parts of the bearings 123 and the shaft seal 125. It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments of the present disclosure have been described with reference to the figures, it will be understood by those of ordinary skill in the art that various changes in form and details may be made therein without departing from the spirit and scope of the present disclosure as defined by the following claims.

What is claimed is:

1. A high-speed rotating machine comprising:
a case;
a balancing unit connected to the case in a state in which a dynamic balance of the balancing unit is already adjusted, and configured to rotate in order to compress or expand air to be supplied to the outside;
a gear box connected to the case; and
a bull gear connected to the gear box and inserted in the balancing unit in order to be connected to the balancing unit and to transfer a rotational force of the gear box to the balancing unit.

2. The high-speed rotating machine of claim 1, wherein the balancing unit comprises:
a pinion gear shaft connected to the bull gear;
at least one bearing provided between the case and the pinion gear shaft to rotatably support the pinion gear shaft;
a bearing housing coupled to the case, the at least one bearing being arranged inside the bearing housing; and
an impeller connected to an end portion of the pinion gear shaft and configured to rotate.

3. The high-speed rotating machine of claim 2, wherein the pinion gear shaft, the at least one bearing, the bearing housing, and the impeller are provided in an assembled state and the balancing unit is provided in the case.

4. The high-speed rotating machine of claim 3, wherein, after the pinion gear shaft, the at least one bearing, the bearing housing, and the impeller are assembled and dynamic balance of each of the pinion gear shaft, the at least one bearing, the bearing housing, and the impeller is adjusted, the balancing unit is provided in the case.

5. The high-speed rotating machine of claim 2, wherein the balancing unit further comprises a shaft seal that is provided between the bearing housing and the pinion gear shaft, the shaft seal being provided at least one of opposite ends of the pinion gear shaft.

6. The high-speed rotating machine of claim 2, wherein the at least one bearing is an angular contact ball bearing that supports an irregular load generated according to rotation of at least one of the pinion gear shaft and the impeller.

7. The high-speed rotating machine of claim 1, wherein the balancing unit comprises at least one un-split bearing.

8. The high-speed rotating machine of claim 7, wherein the at least one un-split bearing is substantially devoid of bearing clearance.

9. A method of assembling a high-speed rotating machine comprising: a case; a balancing unit connected to the case in a state in which a dynamic balance of the balancing unit is already adjusted, and configured to rotate in order to compress or expand air to be supplied to the outside; a gear box connected to the case; and a bull gear connected to the gear box and inserted in the balancing unit in order to be connected to the balancing unit and to transfer a rotational force of the gear box to the balancing unit, the method comprising:
dynamically balancing the balancing unit; and
connecting the balancing unit to the case without disassembling the dynamically balanced balancing unit.
